(19) United States
(12) Patent Application Publication
(10) Pub. No.: US 2017/0146089 A1
(43) Pub. Date: May 25, 2017

(54) Hydraulic Mount and Motor Vehicle Having such a Hydraulic Mount

(71) Applicant: Conti Tech Vibration Control GmbH, Hannover (DE)

(72) Inventors: Robert Genderjahn, Hannover (DE); Max Werhahn, Hannover (DE); Peter Marienfeld, Marklohe (DE)

(73) Assignee: ContiTech Vibration Control GmbH, Hannover (DE)

(21) Appl. No.: 15/319,884

(22) PCT Filed: Apr. 8, 2015
(86) PCT No.: PCT/EP2015/057547

§ 371 Date: Dec. 19, 2016

(30) Foreign Application Priority Data
Jun. 23, 2014 (DE) 10 2014 211 952.9

(51) Int. Cl. F16F 13/26; B62D 63/04; B60K 5/12; F16F 13/08; F16F 13/10

(52) U.S. Cl. CPC F16F 13/264; F16F 13/085; F16F 13/105; B60K 5/1208; B62D 63/04

(57) ABSTRACT

The invention relates to a hydraulic mount (2), comprising a supporting spring (36), a working chamber (4), which is at least partially surrounded by the supporting spring (36) and is filled with a hydraulic fluid, an equalization chamber (6), a hydraulic mount (8), which is arranged between the working chamber (4) and the equalization chamber (6), a throttle channel (10) for the exchange of hydraulic fluid, which throttle channel is formed between the working chamber (4) and the equalization chamber (6), a control membrane (12), which is designed to change a working chamber volume (14) of the working chamber (4), and an actuator (16) for deflecting the control membrane (12), wherein the hydraulic mount (2) has a control channel (24), which ⁴⁰ leads from the working chamber (4) to the control membrane (12), and wherein a flow resistance of the control channel (24) is greater than a flow resistance of the throttle channel (10). The invention further relates to a motor vehicle having such a hydraulic mount (2).

The invention relates to a hydraulic mount, having a load-bearing spring, a working chamber which is at least partially surrounded by the load-bearing spring and which is filled with a hydraulic fluid, an equalization chamber, a partition which is arranged between the working chamber and the equalization chamber, a throttle duct which is formed between the working chamber and the equalization chamber and which serves for the exchange of hydraulic fluid, a control diaphragm which is designed for the variation of a working chamber volume of the working chamber, and an actuator for the deflection of the control diaphragm.

The invention also relates to a motor vehicle which comprises a vehicle frame, an engine and an engine mount in the form of a hydraulic mount, which engine mount produces a connection, with mounting action, between the engine and the vehicle frame.

Hydraulic mounts, also referred to as hydraulic bearings, are known from the prior art. They serve for the elastic support of assemblies, in particular of motor vehicle engines. By way of such hydraulic mounts situated for example between an engine and a chassis of the motor vehicle, it is firstly sought to prevent engine vibrations from being transmitted to the chassis, and secondly, it is sought to achieve that the vibrations of the chassis that arise during driving operation cannot pass, or can pass only having been damped, from the chassis to the engine.

Here, consideration must be given to the known conflict in the field of vibration isolation which consists in the fact that the mount should firstly be as rigid as possible in order to be able to accommodate high loads or mount forces, and secondly must have a soft characteristic in order to isolate to the greatest possible extent vibrations that arise over a broad frequency range.

In their basic version, such hydraulic bearings normally have a rubber element as a load-bearing spring in conjunction with a hydraulic damper. The rubber element is often in the form of a hollow cone. The load-bearing spring can thus form a casing wall of the working chamber. The load-bearing spring is thus also to be understood as a load-bearing body. On the upper, pointed end side of the hollow cone, there is provided an upper cover to which there is attached a connection element for the fastening of the engine. The connection element is normally a threaded bolt which can be screwed to the engine.

Here, the hydraulic damper normally comprises at least two chambers, specifically the stated working chamber and an equalization chamber. In the longitudinal direction of the hydraulic mount, the equalization chamber is normally arranged below the working chamber. To separate the working chamber and the equalization chamber from one another, a partition is arranged between the equalization chamber and the working chamber. Furthermore, a throttle duct which is formed between the working chamber and the equalization chamber is provided for the exchange of hydraulic fluid. The throttle duct is preferably formed at least in sections by the partition. Alternatively, the throttle duct may also be formed separately from the partition. The hydraulic fluid in the working chamber, the equalization chamber and the throttle duct preferably forms the entire hydraulic volume of the hydraulic mount, unless further additional volumes are provided in special embodiments. As hydraulic fluid, use is preferably made of a mixture of oil and water or a fluid with glycol.

When the hydraulic mount is subjected to load, a force acts on the load-bearing spring in a longitudinal direction of the hydraulic mount, such that said load-bearing spring elastically deforms. Said deformation is also referred to as compression of the load-bearing spring. If the working chamber is reduced in size as a result of the compression of the load-bearing spring, the pressure in the working chamber increases, such that a part of the hydraulic fluid of the working chamber flows through the throttle duct into the equalization chamber. The throttle duct constitutes a flow resistance for the flowing hydraulic fluid. The flow through the correspondingly formed throttle duct thus generates dissipation and therefore damping work.

The equalization chamber is preferably equipped with at least one wall part which is deformable in the manner of a diaphragm, such that the part of the hydraulic fluid which flows into the equalization chamber can be accommodated.

A hydraulic mount of said type is known for example from the document DE 10 2010 060 886 A1 or from the document DE 10 2012 008 497 A1.

The damping characteristics of such hydraulic mounts are frequency-dependent owing to their type of construction. Steady-state or quasi-steady-state loads below a frequency of 5 Hz are in this case normally accommodated by the load-bearing spring, which exhibits relatively high stiffness.

Low-frequency vibrations, that is to say vibrations with frequencies of approximately 5 to 20 Hz, which generally occur with large amplitudes, are damped by way of the interaction of the two hydraulic chambers via the throttle duct. Here, the damping arises with the flow of at least a part of the hydraulic fluid of the working chamber through the throttle duct into the equalization chamber and vice versa, with corresponding damping work being performed.

High-frequency vibrations, that is to say vibrations in the frequency range from 20 Hz to for example 50 Hz, 100 Hz or 200 Hz, are transmitted with very little damping, or virtually without damping, owing to the inertia, viscosity and incompressibility of the hydraulic fluid and/or the high stiffness and inertia of the load-bearing spring. Although said vibrations generally occur with small amplitudes, they are of relatively high importance owing to their acoustic action.

For better isolation of such vibrations, the partition between working chamber and equalization chamber may be formed so as to be at least partially flexible or with a free travel. Such a solution is however considered to no longer be sufficient with regard to many isolation requirements, in particular with regard to the ever-increasing demands for comfort in motor vehicles.

With regard to the improved isolation of such vibrations, use is nowadays made of so-called actively controlled hydraulic mounts which have in each case an actuator, also referred to as actuating means. With regard to a basic mode of operation of an actuator, reference is made to the document DE 198 39 464 C2. The actuator is thus in particular an electromagnetic linear actuator and preferably a reluctance linear actuator. It would however basically also be possible for other actuators, in particular other electric actuators, to be used. Actuators which have in each case one stator and one armature have proven to be particularly expedient. Here, the armature is formed so as to be mounted movably with respect to the stator, such that the armature can be deflected relative to the stator in a longitudinal direction of the actuator. The armature is mechanically connected to a control diaphragm which is preferably assigned to the partition. The control diaphragm is thus designed for the variation of the working chamber volume. The control diaphragm may in this case be formed by a flexible part of the partition. It is however also possible for the control diaphragm to be enclosed by the partition and to thus be regarded as a constituent part of the partition. The control diaphragm can be elastically deformed in its normal direction. By virtue of the armature being mechanically coupled to the control diaphragm, it is possible by way of the actuator for the control diaphragm to be deformed in controlled fashion in its normal direction. Here, it may be provided that the armature is not connected directly to the control diaphragm, with a joint mechanism and/or a plunger, for example, rather being provided which are arranged between the armature and the control diaphragm in order to transmit movements and/or forces from the armature to the control diaphragm. With the deformation of the control diaphragm in its normal direction, the hydraulic volume of the working chamber changes. This is the case in particular if the control diaphragm forms a part of the partition with respect to the working chamber. The actuator thus also serves for controlling the hydraulic volume of the working chamber.

If the hydraulic mount is used for the mounting of an engine of a motor vehicle, sensors of the motor vehicle may be used in order to transmit the vibrations emitted by the engine to an as far as possible only highly damped extent to an interior compartment, or to even completely decouple the vibrations of the engine. For this purpose, it is for example possible for a sensor to be provided which can measure vibrations of the engine or of the chassis. Alternatively, it is also possible for multiple sensors to be provided at various locations of the engine and/or of the chassis.

If high-frequency vibrations are detected by the sensor for measuring the vibrations of the chassis, the control diaphragm can be deflected synchronously by the actuator. Here, the direction of the deflection may be defined by the type of construction of the partition or of the control diaphragm. The vibrations of the engine give rise to corresponding high-frequency pressure fluctuations in the hydraulic fluid of the working chamber. With the synchronous deflection of the control diaphragm, said high-frequency pressure fluctuations are as far as possible completely balanced. In the best case, compensation is thus realized, such that said high-frequency vibrations are not transmitted by the hydraulic mount. Correspondingly high-frequency vibrations thus do not give rise to noise emissions, or give rise to only very low noise emissions, in the interior compartment of the motor vehicle.

By way of the discussed actuation of the actuator and of the corresponding action on the control diaphragm, it is thus sought to realize a lowering of the dynamic spring rate in the range of the high-frequency vibrations. In other words, it is sought to switch the hydraulic mount into a “soft” state for high-frequency vibrations. In the presence of low-frequency vibrations or quasi-steady-state loads of the hydraulic mount, the control diaphragm is not actively actuated. If the pressure in the working chamber now increases, the control diaphragm can yield by being deflected out of the working chamber by the hydraulic fluid. During passive operation, the control diaphragm thus yields to a pressure from the working chamber. Owing to the flexibility of the control diaphragm and its hydraulic connection to the working chamber, the control diaphragm reduces the dynamic stiffness of the hydraulic mount. For low-frequency vibrations and/or quasi-steady-state loads, it is furthermore the case that reduced damping is realized. A so-called damping loss is also spoken of. In some cases, tests have been carried out to compensate said damping loss by increasing the stiffness of the control diaphragm. This however has an adverse effect on the isolation characteristics in the relatively high-frequency range, in particular between 20 Hz and 200 Hz. Furthermore, the structural space required is enlarged if the stiffness of the control diaphragm is to be increased, because the actuator must be dimensioned to be correspondingly larger in order to overcome the correspondingly larger forces for the stiffer control diaphragm.

The invention is therefore based on the object of providing a hydraulic mount in the case of which the stated disadvantages are eliminated or reduced. The hydraulic mount should preferably be designed to offer the best possible damping or isolation, respectively, for quasi-steady-state loads, in the low-frequency vibration range and in the relatively high-frequency vibration range.

According to a first aspect, the object is achieved by way of the hydraulic mount according to the invention, having a load-bearing spring, a working chamber which is at least partially surrounded by the load-bearing spring and which is filled with a hydraulic fluid, an equalization chamber, a partition which is arranged between the working chamber and the equalization chamber, a throttle duct which is formed between the working chamber and the equalization chamber and which serves for the exchange of hydraulic fluid, a control diaphragm which is designed for the variation of a working chamber volume of the working chamber, and an actuator for the deflection of the control diaphragm, wherein the hydraulic mount has a control duct which leads from the working chamber to the control diaphragm, and wherein a flow resistance of the control duct is greater than a flow resistance of the throttle duct.

Here, the invention is based on the concept of reducing an influence of said flexibility of the control diaphragm on the dynamic stiffness of the hydraulic mount in the presence of low-frequency vibrations and/or in the presence of quasi-steady-state loads. By virtue of the fact that the flow resistance of the control duct is greater than a flow resistance of the throttle duct, the throttle duct, or the equalization chamber hydraulically coupled to the working chamber by way of the throttle duct, dominates an influence on the dynamic stiffness of the hydraulic mount in the presence of quasi-steady-state loads and/or low-frequency vibrations.

If, in the case of the hydraulic mount according to the invention, a quasi-steady-state load or excessively low-frequency vibrations now occur, these are at least partially accommodated by the load-bearing spring, which has a relatively high stiffness. Owing to the relatively high flow resistance of the control duct in relation to the throttle duct, only a negligibly small volume flow is forced through the control duct in this load situation. To influence the stiffness for such quasi-steady-state loading, an increased exchange of hydraulic fluid would however be required, because quasi-steady-state loads or low-frequency vibrations generally have a large amplitude. A corresponding exchange of hydraulic fluid however does not occur owing to the flow resistance of the control duct. Low-frequency vibrations with large amplitudes are damped by way of the interaction of the working chamber and of the equalization chamber via the throttle duct. Here, relatively large amounts of hydraulic fluid are conducted from the working chamber into the equalization chamber and vice versa. Owing to the relatively high flow resistance of the control duct, only a negligibly small volume flow is forced through the control duct to the control diaphragm. Therefore, the dynamic stiffness provided for the low-frequency vibration range and the damping characteristics of the hydraulic mount are not influenced, or are influenced only very little, by the control diaphragm. The damping action is thus dominated by the throttle duct, and is maintained in the desired manner.

If high-frequency vibrations with generally small amplitudes occur, the hydraulic fluid, owing to its inertia and viscosity, cannot flow through the throttle duct in a manner or quantity such that dissipation and corresponding damping of the vibrations occur in the throttle duct. Owing to the relatively high flow resistance of the control duct, the hydraulic fluid likewise cannot flow through the control duct in a manner or quantity such that dissipation and corresponding damping of the high-frequency vibrations occur in the control duct. The high-frequency vibrations are thus not damped by dissipation in either of the two ducts. Rather, the control duct, owing to its hydraulic connection between the working chamber and the control diaphragm, is designed to likewise transmit high-frequency vibrations originating from the control diaphragm into the working chamber. There is no need for an exchange of large quantities of hydraulic fluid for this purpose. This rather involves pulsed movements of the hydraulic fluid in the control ducts. With a corresponding introduction of the high-frequency vibrations by way of the control diaphragm, the high-frequency vibrations that arise in the working chamber as a result of the external load on the hydraulic mount are isolated. The isolation of the high-frequency vibrations in the working chamber results in a lowering of the dynamic spring rate of the hydraulic mount in the range for such vibrations. With the embodiment according to the invention of the hydraulic mount, said hydraulic mount can therefore also be switched into a “soft” state for high-frequency vibrations.

A preferred embodiment of the hydraulic mount is characterized in that the flow resistance of the control duct in a vibration frequency range between 5 Hz and 15 Hz is greater than a flow resistance of the throttle duct in a vibration frequency range between 5 Hz and 15 Hz. With this embodiment, it is ensured that the flexibility of the control diaphragm during passive operation has no or at least substantially no adverse influence on the damping by way of the throttle duct in the abovementioned frequency spectrum of the low-frequency vibrations. In said frequency spectrum, the low-frequency vibrations are thus significantly damped by the throttle duct. By virtue of the fact that only a negligibly small fraction of the hydraulic fluid flows through the control duct, substantially no damping losses arise. It is thus possible for the damping for the stated frequency spectrum to be defined or set in a particularly simple manner through structural configuration of the throttle duct.

A further preferred embodiment of the hydraulic mount is characterized in that the flow resistance of the control duct is at least five times the flow resistance of the throttle duct. By virtue of the fact that the flow resistance of the control duct is at least five times, preferably at least ten times or at least fifteen times, the flow resistance of the throttle duct, it is ensured that only a very small part of the hydraulic fluid is forced out of the working chamber through the control duct in the presence of low-frequency vibrations and/or quasi-steady-state loads. Despite the flexibility of the control diaphragm during passive operation, said control diaphragm thus has substantially no adverse influence on the damping by way of the throttle duct and/or by way of the load-bearing spring. The flexibility of the control diaphragm is thus effectively decoupled for quasi-steady-state loads and/or low-frequency vibrations.

A further preferred embodiment of the hydraulic mount is characterized in that the throttle duct has a low-pass characteristic with a cutoff frequency f1, in particular with f1 between 10 Hz and 30 Hz. It is thus possible for the throttle duct to have a cutoff frequency of f1 between 15 Hz and 25 Hz, in particular of approximately 20 Hz. This prevents the throttle duct from being designed for the effective damping of high-frequency vibrations. It is thus possible for the control diaphragm and the control duct to be configured, optimally in terms of construction, separately from one another in order to as far as possible isolate the high-frequency vibrations. To provide the throttle duct with a low-pass characteristic, it has been found in practice that this can be achieved simply by way of a tubular form of the duct. Here, the associated cutoff frequency may be structurally defined for example by way of the length of the duct, by way of the cross section of the duct, by way of bends and/or by way of projections protruding into the duct.

A further preferred embodiment of the hydraulic mount is characterized in that the control duct has a low-pass characteristic with a cutoff frequency of f2, in particular with f2 between 2 Hz and 7 Hz. It is thus possible for the cutoff frequency of the control duct to be approximately 5 Hz. With such a cutoff frequency for the low-pass characteristic of the control duct, it can be ensured in a particularly reliable manner that the control duct has no influence, or at least only a very small influence, on the damping of low-frequency vibrations by the throttle duct. This is because the low-frequency vibrations normally have a frequency spectrum from 5 Hz to 20 Hz. By way of the abovementioned low-pass characteristic of the control duct, vibrations from said frequency spectrum are however not allowed to pass through from the control duct to the control diaphragm. The control diaphragm thus does not influence said vibrations. To provide the control duct with a low-pass characteristic, it has been found in practice in this case too that this can be achieved simply by way of a tubular form of the duct. Here, the associated cutoff frequency may be structurally defined for example by way of the length of the duct, by way of the cross section of the duct, by way of bends and/or by way of projections protruding into the duct.

A further preferred embodiment of the hydraulic mount is characterized in that the cutoff frequency f2 is lower than the cutoff frequency f1. The cutoff frequency of the control duct is thus lower than the cutoff frequency of the throttle duct. This ensures that the influence of the control diaphragm on the damping by the throttle duct is limited or even minimized.

A further preferred embodiment of the hydraulic mount is characterized in that a cross section of the control duct is smaller than a cross section of the throttle duct. The cross section of a duct is significantly responsible for the flow resistance of a duct. In particular, the minimal cross section or cross-sectional diameter of a duct contributes to the definition of the flow resistance of the duct. To now ensure that the control duct has a higher flow resistance than the throttle duct, it is provided that the cross section of the control duct is smaller than the cross section of the throttle duct. Said cross sections preferably refer in each case to the minimum cross section or in each case to the mean cross section.

A further preferred embodiment of the hydraulic mount is characterized in that the smallest cross section of the throttle duct is at least twice the smallest cross section of the control duct. The smallest cross section of the throttle duct particularly preferably amounts to at least three times, at least four times at least six times the smallest cross section of the control duct. These embodiments ensure that the flow resistance of the control duct is considerably greater than the flow resistance of the throttle duct. If, for simplicity, it is assumed that the flow resistance varies proportionally to the square of the cross section, the flow resistance of the control duct amounts to at least four times the flow resistance of the throttle duct. With such a large difference between the two flow resistances, the control duct scarcely offers possibilities for influencing the damping by the throttle duct in the presence of low-frequency vibrations and/or in the presence of quasi-steady-state loads.

A further preferred embodiment of the hydraulic mount is characterized in that a length of the control duct is greater than a length of the throttle duct. Aside from the cross section of a duct, the length of a duct significantly influences the flow resistance thereof. By virtue of the control duct being formed so as to be longer than the throttle duct, it is ensured that the control duct has a greater flow resistance than the throttle duct, such that the abovementioned advantages can be realized.

A further preferred embodiment of the hydraulic mount is characterized in that the control duct has flow resistance elements and/or flow diverting elements which project radially on the inside. A flow resistance of a control duct may have a pressure component and a friction component. With the abovementioned elements, it is preferably possible for the pressure component of the flow resistance to be varied. Now, if quasi-steady-state loads or low-frequency vibrations occur, a liquid flow entering the control duct strikes said elements. This is the case in particular if the vibrations or loads occur with large amplitudes. It is thus possible, by way of the abovementioned elements, for the control duct to be structurally designed to at least substantially decouple quasi-steady-state loads and/or a low-frequency vibrations from the control diaphragm.

A further preferred embodiment of the hydraulic mount is characterized in that an inner wall of the control duct has a roughness of at least 1.4 μm, preferably of at least 1.6 μm. The roughness of the inner wall has a significant influence on the flow resistance of the control duct. With the abovementioned roughness, it is ensured that the flow resistance of the control duct is high enough to realize as small as possible an influence on the damping of low-frequency vibrations by the throttle duct.

A further preferred refinement of the hydraulic mount is characterized in that the control duct leads from the partition to the control diaphragm. The control duct is thus arranged between the working chamber and the control diaphragm. With the arrangement of the control duct at the partition, it is possible for the working chamber volume of the working chamber to be directly influenced by way of the control diaphragm. It is thus possible for the control diaphragm to perform its intended function, specifically the desired isolation of high-frequency vibrations.

A further preferred embodiment of the hydraulic mount is characterized in that a pressure chamber is provided, wherein the control diaphragm is arranged between the control duct and the pressure chamber. With a deflection of the control diaphragm, it is thus the case that not only the volume of the working chamber but also the volume of the pressure chamber is varied. Such a construction is basically known from the prior art and is also referred to as an inverted construction. This is because the pressure chamber may have a pressure which is higher than the nominal pressure in the working chamber. In the event of an actuation of the control diaphragm, it is thus the case that the forces acting on the hydraulic mount from the outside and the force of the armature act in opposite directions, such that regulation is also possible in the resonance range. The pressure chamber may be arranged to a side, facing toward the working chamber, of the partition, such that an armature plunger of the armature can lead through a bore of the partition, wherein the rest of the armature and the stator are arranged on that side of the partition which is averted from the working chamber.

A further preferred embodiment of the hydraulic mount is characterized in that the throttle duct and the control duct are formed separately from one another. The flows of hydraulic fluid in the ducts thus do not directly influence one another. It is thus possible for the desired damping by way of the throttle duct and the desired isolation by way of the control diaphragm to be adapted separately from one another.

According to a further aspect, the object mentioned in the introduction is also achieved by way of a motor vehicle which comprises a vehicle frame, an engine and an engine mount which produces a connection, with mounting action, between the engine and the vehicle frame, wherein the engine mount is formed by a hydraulic mount according to the invention. Here, features, details and advantages that have been described in conjunction with the hydraulic mount according to the invention self-evidently also apply in conjunction with the motor vehicle according to the invention and vice versa in each case, such that reference is always or can always be made reciprocally with respect to the disclosure of the individual aspects of the invention.

The invention will be described below, without restriction of the general concept of the invention, on the basis of exemplary embodiments and with reference to the drawings. In the drawings:

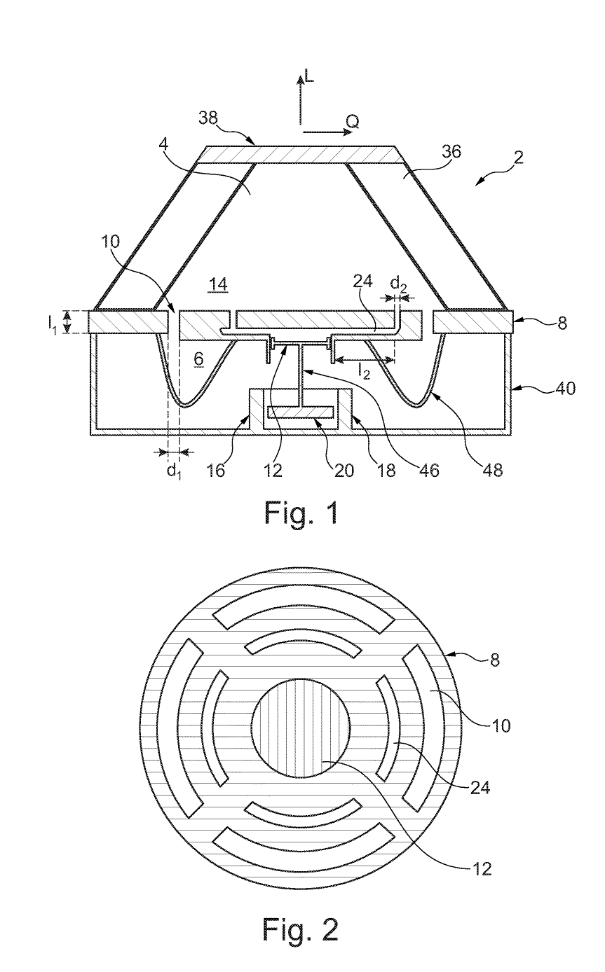

FIG. 1 shows a schematic cross-sectional view of the hydraulic mount in a first embodiment,

FIG. 2 shows a schematic view of the hydraulic mount along a section A-A, and

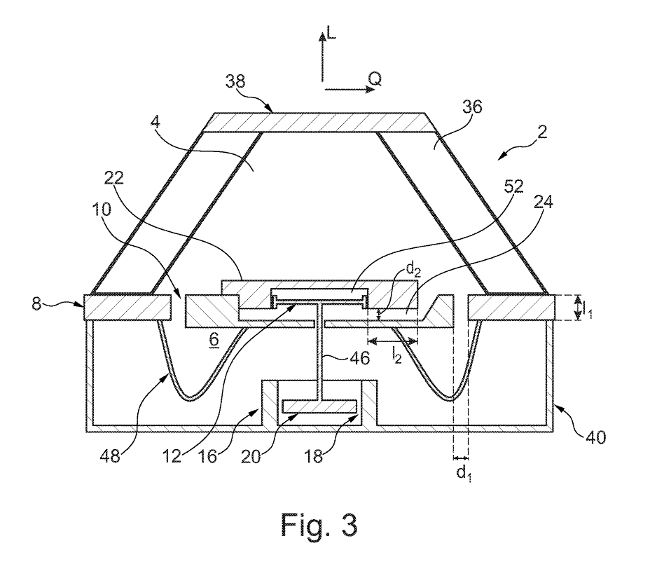

FIG. 3 shows a schematic cross-sectional view of the hydraulic mount in a second embodiment.

FIG. 1 shows a hydraulic mount 2. The hydraulic mount 2 comprises a load-bearing spring 36 in the form of a rubber element. Said load-bearing spring 36 is, in the conventional manner, in the form of a hollow body, wherein the top side of the load-bearing spring 36 has a cover 38. A connection element (not illustrated) for the fastening of an engine is normally attached to the cover 38. In a simple embodiment, the connection element is a threaded bolt which can be screwed to the engine. The bottom side of the load-bearing spring 36 is adjoined by the partition 8. The working chamber 4 is formed between the load-bearing spring 36, the cover 38 and the partition 8. The working chamber 4 is filled with a hydraulic fluid. This is preferably a mixture of oil and water. Situated adjacently below the partition 8 in the longitudinal direction L is the hollow cylindrical base housing 40, the interior space of which is divided by a flexible separating body 48. The separating body may for this purpose be produced from elastic material, and/or may be in the form of a rolling diaphragm. The separating body 48 is of ring-shaped form, such that a radially inside edge and a radially outside edge are fastened, spaced apart from one another, to the partition 8. The space enclosed by the partition 8 and the separating body 48 forms the equalization chamber 6 of the hydraulic mount 2. The equalization chamber 6 is preferably likewise filled with hydraulic fluid, which is preferably a mixture of oil and water. It can thus be seen from FIG. 1 that the partition 8 is arranged between the working chamber 4 and the equalization chamber 6.

For the damping of low-frequency vibrations which are exerted by the engine on the load-bearing spring 36 via the cover 38 and which thus also act on a working chamber volume 14 of the working chamber 4, a throttle duct 10 is provided which is formed between the working chamber 4 and the equalization chamber 6 and which serves for the exchange of hydraulic fluid. As illustrated in FIG. 1, the throttle duct 10 is for example formed by, or enclosed in, the partition 8. If the load-bearing spring 36 is compressed as a result of the vibrations, this normally leads to an increase of the pressure of the hydraulic fluid in the working chamber 4 and/or to a decrease in size of the working chamber volume 14 of the working chamber 4. In both cases, a volume flow of the hydraulic fluid takes place from the working chamber 4 through the throttle duct 10 into the equalization chamber 6. The throttle duct 10 has a diameter adapted such that dissipation occurs, and the vibrations acting on the load-bearing spring 36 are damped. The damping by way of the throttle duct 10 is however effective only for low-frequency vibrations. In the presence of relatively high-frequency vibrations, for example above 20 Hz, virtually no damping or prevention of vibrations whatsoever is effected by way of the throttle duct 10.

For the isolation of vibrations with a frequency of greater than 20 Hz, the hydraulic mount 2 has a control diaphragm 12 which is fluidically connected to the working chamber 4. For this purpose, a control duct 24 extends from the working chamber 4 to the control diaphragm 12, by way of which control duct the hydraulic connection from the working chamber 4 to the control diaphragm 12 is produced. In other words, the control duct 24 leads from the working chamber 4 to the control diaphragm 12. One end of the control duct 24 is open toward the working chamber 4. For this purpose, the control duct 24 is assigned to the partition 8, wherein at least one section of the control duct 24 may be formed by the partition 8. The remaining section of the control duct 24 may be connected cohesively, in positively locking fashion and/or in non-positively locking fashion to the partition 8. The other end of the control duct 24 is adjoined by the control diaphragm 12. Said control diaphragm closes said end of the control duct 24. Thus, the control diaphragm 12 communicates with the working chamber volume 14 of the working chamber 4.

The control diaphragm 12 is designed to be displaceable or elastically deformable in the longitudinal direction L. In accordance with its variability of said type, the working chamber volume 14 of the working chamber 4 increases or decreases in size. Said variability of the control diaphragm 12 is utilized advantageously to as far as possible isolate relatively high-frequency vibrations. For this purpose, the control diaphragm 12 is, at its side averted from the control duct 24 or from the working chamber 4, mechanically connected to an armature plunger 46 of an armature 20 of an actuator 16 of the hydraulic mount 2. The actuator 16 furthermore has a stator 18 which is fastened to the base housing 40, with the armature 20 being arranged so as to be mounted movably with respect to said stator. The actuator 16 is an electromagnetic linear actuator. Other actuators are however also conceivable.

As already discussed, the control diaphragm 12 serves for the isolation of high-frequency vibrations of the hydraulic mount 2 or of an engine with respect to a chassis. The actuator 16 for the actuation of the control diaphragm 12 is thus preferably activated only if such high-frequency vibrations occur. In the presence of low-frequency vibrations and/or in the presence of quasi-steady-state loads of the hydraulic mount 2, there is thus the risk in the case of known hydraulic mounts that the control diaphragm 12, with its hydraulic connection to the working chamber 4, reduces the dynamic stiffness of the hydraulic mount 2 for a low-frequency vibrations and/or quasi-steady-state loads, which can lead to an impairment of the damping of the low-frequency vibrations and/or of the quasi-steady-state loads. It is thus provided, for the hydraulic mount 2 according to the invention, that the flow resistance of the control duct 24 is greater than a flow resistance of the throttle duct 10. If low-frequency vibrations with large amplitudes now occur, relatively large amounts of the hydraulic fluid are conducted from the working chamber 4 through the throttle duct 10 into the equalization chamber 6 and vice versa. Dissipation then occurs in the throttle duct 10, which leads to damping of the low-frequency vibrations. Owing to the relatively high flow resistance of the control duct 24, only a very small amount, or an even negligibly small amount, of the hydraulic fluid passes through the control duct 24 to the control diaphragm 12. Therefore, the vibration characteristics of the hydraulic mount 2 in the presence of low-frequency vibrations are effectively at least substantially not influenced by the control diaphragm 12. It is rather the case that the throttle duct 10, and the two chambers 4, 6 that are fluidically connected by way of the throttle duct 10, dominate the low-frequency vibration characteristics of the hydraulic mount 2. A corresponding situation applies in the case of quasi-steady-state loads. By contrast, if high-frequency vibrations with small amplitudes occur, no exchange of large amounts of hydraulic fluid between the working chamber 4 and the equalization chamber 6 occurs through the throttle duct 10. This can be attributed firstly to said small amplitudes and secondly to the inertia and viscosity of the hydraulic fluid. The throttle duct 10 thus does not contribute to significant damping of the high-frequency vibrations. The high-frequency vibrations can however be at least partially isolated by the control diaphragm 12 owing to its hydraulic connection to the working chamber 4 by way of the control duct 24. There is no need for an exchange of large quantities of hydraulic fluid for this purpose. It is rather possible by way of the control diaphragm 12 for likewise high-frequency vibrations to be generated, which are transmitted by way of the hydraulic fluid in the control duct 12 to the hydraulic fluid in the working chamber 4. With the corresponding introduction of the high-frequency vibrations by way of the control diaphragm 12, the high-frequency vibrations of the hydraulic mount 2 that may arise in the working chamber 4 as a result of external loads on the hydraulic mount 2 are then isolated. With the control diaphragm 12 and the control duct 24, the hydraulic mount 2 is thus designed to isolate high-frequency vibrations of the hydraulic mount 2, which leads to a lowering of the dynamic spring rate of the hydraulic mount 2 in the range of such vibrations.

To ensure that the control diaphragm 12 has the least possible influence, or even no influence whatsoever, on the damping characteristics of the throttle duct 10 with regard to low-frequency vibrations, it is, as discussed, provided that the flow resistance of the control duct 24 is higher than the flow resistance of the throttle duct 10. This may be realized for example by virtue of the cross section of the throttle duct 10 being larger than the cross section of the control duct 24. The cross section may refer for example to the cross-sectional area of the respective duct. The cross section may alternatively also refer to the cross-sectional diameter of the respective duct. Viewing FIG. 1, it may thus be provided that the cross-sectional diameter d1 of the throttle duct 10 is twice as large as the cross-sectional diameter d2 of the control duct 24. To realize the relatively high flow resistance of the control duct 24, it may alternatively or additionally be provided that the length I1 of the throttle duct 10 is smaller than the length I2 of the control duct 24. The length I2 of the control duct 24 is preferably at least twice the length I1 of the throttle duct 10.

Referring to FIG. 2, it is pointed out that the throttle duct 10 and/or the control duct 24 may in each case be formed by multiple tubular connections. The respective duct cross section, the respective flow resistance and/or respective other physical characteristics of the throttle duct 10 and/or of the control duct 24 thus represent the corresponding physical characteristics, which are in each case added together and/or superposed, of said tubular connections. As can be seen from FIG. 2, the throttle duct 10 may be formed from four tubular connections, arranged so as to be distributed over the circumference of the partition 8, between the working chamber 4 and the equalization chamber 6, wherein the cross section of the throttle duct 10 is defined by addition of the individual cross sections of the tubular connections. A corresponding situation may apply to the control duct 24.

FIG. 3 schematically illustrates a further embodiment of the hydraulic mount 2. The hydraulic mount 2 is of substantially identical construction to the hydraulic mount 2 discussed with reference to FIG. 1. Analogous explanations, features and/or advantages thus apply. The hydraulic mount 2 from FIG. 3 however differs substantially with regard to the construction of the control diaphragm 12, of the armature 20 connected to the control diaphragm 12, and of the partition 8.

As can be seen from FIG. 3, the armature plunger 46 of the armature 20 leads through the partition 8. For this purpose, the armature plunger 46 may be mounted on and/or sealed off against the partition 8. The control diaphragm 12 adjoins that end of the armature plunger 46 which is averted from the stator 18. The control diaphragm 12 is inserted into a pressure chamber housing 22, wherein a pressure chamber 52 is formed between the control diaphragm 12 and the pressure chamber housing 22. The control diaphragm 12 is thus arranged between the control duct 24 and the pressure chamber 52. The pressure chamber housing 22 may be attached to the partition 8, specifically preferably to that side of the partition 8 which faces toward the working chamber 4. Alternatively, the pressure chamber housing 22 may be formed by the partition 8. The pressure chamber 52 may be filled with dried air, gas and/or a gas mixture. With the deflection of the control diaphragm 12, it is thus the case that not only the volume of the working chamber 4 but also the volume of the pressure chamber 52 is varied. Such a construction is basically known from the prior art and is also referred to as an inverted construction.

### LIST OF REFERENCE SIGNS

### Part of the Description

d1 Cross-sectional diameter
d2 Cross-sectional diameter
L Longitudinal direction
l1 Length
l2 Length
Q Transverse direction
2 Hydraulic mount
4 Working chamber
6 Equalization chamber
8 Partition
10 Throttle duct
12 Control diaphragm
14 Working chamber volume
16 Actuator
18 Stator
20 Armature
22 Pressure chamber housing
24 Control duct
36 Load-bearing spring
38 Cover
40 Base housing
46 Plunger
48 Separating body
52 Pressure chamber

1-15. (canceled)

16. A hydraulic mount comprising:
a load-bearing spring;
a working chamber at least partially surrounded by the load-bearing spring, wherein the working chamber is filled with a hydraulic fluid;
an equalization chamber;
a partition arranged between the working chamber and the equalization chamber;
a throttle duct formed between the working chamber and the equalization chamber, wherein the throttle duct serves for exchange of hydraulic fluid;
a control diaphragm which is designed for the variation of a working chamber volume of the working chamber; and,
an actuator for deflection of the control diaphragm;
wherein the hydraulic mount comprises a control duct which leads from the working chamber to the control diaphragm, and wherein flow resistance of the control duct is greater than flow resistance of the throttle duct.

17. The hydraulic mount as claimed in claim 16, wherein the flow resistance of the control duct in a vibration frequency range between 5 Hz and 15 Hz is greater than the flow resistance of the throttle duct in a vibration frequency range between 5 Hz and 15 Hz.

18. The hydraulic mount as claimed in claim 16, wherein the flow resistance of the control duct is at least five times the flow resistance of the throttle duct.

19. The hydraulic mount as claimed in claim 16, wherein the throttle duct has a low-pass characteristic with a cutoff frequency f1.

20. The hydraulic mount as claimed in claim 19, wherein the cutoff frequency f1 is between 10 Hz and 30 Hz.

21. The hydraulic mount as claimed in claim 16, wherein the control duct has a low-pass characteristic with a cutoff frequency of f2.

22. The hydraulic mount as claimed in claim 21, wherein the cutoff frequency f2 is between 2 Hz and 7 Hz.

23. The hydraulic mount as claimed in claim 19, wherein the control duct has a low-pass characteristic with a cutoff frequency of f2, and wherein the cutoff frequency f2 is lower than the cutoff frequency f1.

24. The hydraulic mount as claimed in claim 16, wherein a cross section of the control duct is smaller than a cross section of the throttle duct.

25. The hydraulic mount as claimed in claim 24, wherein the cross section of the throttle duct is at least twice the cross section of the control duct.

26. The hydraulic mount as claimed in claim 16, wherein a length of the control duct is greater than a length of the throttle duct.

27. The hydraulic mount as claimed in claim 16, wherein the control duct comprises flow resistance elements which project radially on the inside of the control duct.

28. The hydraulic mount as claimed in claim 16, wherein the control duct comprises flow diverting elements which project radially on the inside of the control duct.

29. The hydraulic mount as claimed in claim 16, wherein the control duct comprises flow resistance elements and flow diverting elements which project radially on the inside of the control duct.

30. The hydraulic mount as claimed in claim 16, wherein an inner wall of the control duct has a roughness of at least 1.4 μm.

31. The hydraulic mount as claimed in claim 16, wherein the control duct leads from the partition to the control diaphragm.

32. The hydraulic mount as claimed in claim 16 further comprising a pressure chamber, wherein the control diaphragm is arranged between the control duct and the pressure chamber.

33. The hydraulic mount as claimed in claim 16, wherein the throttle duct and the control duct are formed separately from one another.

34. A hydraulic mount comprising:
a load-bearing spring;
a working chamber at least partially surrounded by the load-bearing spring, wherein the working chamber is filled with a hydraulic fluid;
an equalization chamber;
a partition arranged between the working chamber and the equalization chamber;
a throttle duct formed between the working chamber and the equalization chamber, wherein the throttle duct serves for exchange of hydraulic fluid;
a control diaphragm which is designed for the variation of a working chamber volume of the working chamber;
an actuator for deflection of the control diaphragm; and, a control duct which leads from the working chamber to the control diaphragm;
wherein the throttle duct has a low-pass characteristic with a cutoff frequency f1, wherein the control duct has a low-pass characteristic with a cutoff frequency of f2, and wherein the cutoff frequency f2 is lower than the cutoff frequency f1.

35. A motor vehicle comprising:
a vehicle frame;
an engine; and,
an engine mount which produces a connection, with mounting action, between the engine and the vehicle frame;
wherein the hydraulic mount comprises a load-bearing spring, a working chamber at least partially surrounded by the load-bearing spring, an equalization chamber, a partition arranged between the working chamber and the equalization chamber, a throttle duct formed between the working chamber and the equalization chamber, a control diaphragm which is designed for the variation of a working chamber volume of the working chamber, and an actuator for deflection of the control diaphragm; and,
wherein the hydraulic mount comprises a control duct which leads from the working chamber to the control diaphragm, wherein flow resistance of the control duct is greater than flow resistance of the throttle duct, wherein the working chamber is filled with a hydraulic fluid, and wherein the throttle duct serves for exchange of hydraulic fluid;
